(19) United States
(12) Patent Application Publication
(10) Pub. No.: US 2025/0363059 A1
(43) Pub. Date: Nov. 27, 2025

(54) METHOD AND DEVICE FOR UPDATING DUAL-ORDER-GUARANTEED MAPPING TABLE

(71) Applicant: Korea Advanced Institute of Science And Technology, Daejeon (KR)

(72) Inventors: Youjip Won, Daejeon (KR); Jieun Kim, Daejeon (KR)

(73) Assignee: Korea Advanced Institute of Science And Technology, Daejeon (KR)

(21) Appl. No.: 19/289,664

(22) Filed: Aug. 4, 2025

Related U.S. Application Data
(63) Continuation of application No. PCT/KR2024/001401, filed on Jan. 30, 2024.

(30) Foreign Application Priority Data
Feb. 15, 2023 (KR) 10-2023-0020159
Jan. 26, 2024 (KR) 10-2024-0012266

(51) Int. Cl. G06F 12/1009; G06F 12/02

(52) U.S. Cl. CPC G06F 12/1009; G06F 12/0223; G06F 2212/1008

(57) ABSTRACT

The present disclosure relates to a method and a device for updating a dual-order-guaranteed mapping table. The present invention can: detect a write command indicating order constraints on write requests for two streams; generate a mapping table for epochs of streams detected from the write command; and record the streams in a storage according to the order constraints while updating the mapping table through mapping information about each epoch in the streams by using the mapping table.

### CROSS-REFERENCE TO RELATED APPLICATION(S)

This U.S. non-provisional application is a continuation application of PCT International Application PCT/KR2024/001401, which has an International filing date of Jan. 30, 2024, and claims priority under 35 U.S.C. 119 to Korean Patent Application Nos. 10-2023-0020159, filed on Feb. 15, 2023, and 10-2024-0012266, filed on Jan. 26, 2024, in the Korean intellectual property office, the disclosures of which are herein incorporated by reference in its entirety.

### BACKGROUND

### 1. Field of the Invention

The present disclosure relates to a method and device for updating a dual-order-guaranteed mapping table.

### 2. Description of the Related Art

In general, a host sets an order-guaranteed command flag to a write request for a stream to ensure that the write order between streams is guaranteed. That is, if the order-guaranteed command flag is set to the write request for any stream by the host, the stream is permanently recorded in a storage before other streams. However, this approach only guarantees the write order between a corresponding write request and write requests that arrive thereafter.

### SUMMARY

The present disclosure provides a method and device for updating a mapping table that guarantees dual order in which streams may be permanently recorded in a storage in order of epoch IDs according to a write command that simultaneously belongs to two streams.

In the present disclosure, a computer device for updating a dual-order-guaranteed mapping table may include a storage; and a processor configured to connect to the storage, and to execute at least one instruction stored in the storage, and the processor may include a storage controller configured to detect a write command indicating order constraints of write requests for two streams, to generate a mapping table for epochs of the streams based on the write command, and to record the streams in the storage according to the order constraints using the mapping table; and a flash translation layer configured to update the mapping table with mapping information of each epoch.

In the present disclosure, a method for updating a dual-order-guaranteed mapping table of a computer device may include detecting a write command indicating order constraints of write requests for two streams; generating a mapping table for epochs of the streams based on the write command; and recording the streams in the storage according to the order constraints using the mapping table while updating the mapping table with mapping information of each epoch.

In the present disclosure, a computer program may be stored in a non-transitory computer-readable recording medium to execute a method for updating a dual-order-guaranteed mapping table on a computer device, and the method may include detecting a write command indicating order constraints of write requests for two streams; generating a mapping table for epochs of the streams based on the write command; and recording the streams in the storage according to the order constraints using the mapping table while updating the mapping table with mapping information of each epoch.

According to the present disclosure, it is possible to guarantee the order in which a write command simultaneously belonging to two streams is permanently recorded. By delaying mapping information update of a write command that violates the order and by performing data recording on a flash chip regardless of the order, it is possible to guarantee the write order while minimizing overhead required for guaranteeing the order.

### BRIEF DESCRIPTION OF THE DRAWINGS

FIG. 1 illustrates a state of an epoch defined in the present disclosure.

FIG. 2 is a diagram illustrating a schematic configuration of a computer device 100 for updating a dual-order-guaranteed mapping table according to various example embodiments.

FIG. 3 is a diagram illustrating a detailed configuration of a processor of FIG. 2.

FIG. 4 is a flowchart illustrating a method for updating a dual-order-guaranteed mapping table of a computer device according to various example embodiments.

FIG. 5 is a diagram for exemplarily describing an operation of generating delayed mapping entries of FIG. 4.

FIG. 6 is a flowchart illustrating an operation of recording streams while updating the mapping table of FIG. 4.

### DETAILED DESCRIPTION

The present disclosure proposes a storage controller and a flash translation layer (FTL) that may record, in a storage, a write request subject to two order constraints, in accurate order. A write command includes two pairs of stream and epoch IDs (hereinafter, <first stream ID, first epoch ID>, <second stream ID, second epoch ID>), which represent storage order constraints of a write request. The storage controller proposed herein decodes a write command received from a host and identifies two pairs of stream and epoch IDs. When data of a write request sent from the host is recorded in a flash chip and mapping information of a logical page number (LPN) and a physical page number (PPN) of corresponding write is recorded in a mapping table, the corresponding write is permanently stored in the storage. The storage controller and the FTL proposed herein, when the write request received from the host simultaneously belongs to two streams, record data in the flash chip regardless of the order, but instead, reflect LPN and PPN mapping information of write to the mapping table in ascending order of epoch IDs in each stream. To this end, the storage controller and the FTL proposed herein manage a data structure for streams and epochs and updates mapping of a write request only when mapping for a leader epoch is updated in both streams by referring to the data structure.

### <Type of Write Request>

The present disclosure classifies a write request into three types. The first type is a write request that does not have write order constraints. In this case, a first stream ID and a second stream ID of a write request command are all 0. The second type is a write request that has write constraints in a single stream. In this case, the first stream ID is an integer greater than 0. The third type is a write request that requires dual-order guarantee and has order constraints in two streams. In this case, both the first stream ID and the second stream ID are integers greater than 0.

### <Data Structure>

In the present disclosure, the FTL manages a stream table data structure that stores information on the entire streams. Each stream has a set of epochs, an ID of a recently permanently recorded epoch, and a set of delayed mapping information. An epoch is a set of write requests, and when an epoch ID is included in a write command sent from the host, a write request belongs to an epoch corresponding to the ID. In a case in which two streams and epoch ID are included in the write command sent from the host, the storage controller proposed herein generates a new data structure if a stream data structure is not yet present when servicing the corresponding write command, and generates a new epoch data structure if an epoch data structure corresponding to the epoch ID is not present. Each epoch has three counters. The first is a counter (block counter) that counts the total number of logical blocks belonging to an epoch. Three counter values are initialized to 0 when the epoch data structure is newly generated. The controller increases a counter value by 1 every time a write request is serviced for a new logical block. The second is a counter (durable block counter) that counts the number of logical blocks in which write data is stored in a flash chip among logical block belonging to an epoch. In this counter, when a write buffer flush is performed, the controller increases a corresponding counter value by 1 after data of a logical block belonging to an epoch is completely recorded in a flash chip. The third is a counter (mapped block counter) that counts the number of logical blocks in which mapping information is reflected to a mapping table among logical blocks belonging to an epoch. The FTL reflects mapping information of a logical block to the mapping table and then increases a mapped block counter of an epoch to which the corresponding logical block belongs.

### <State of Epoch>

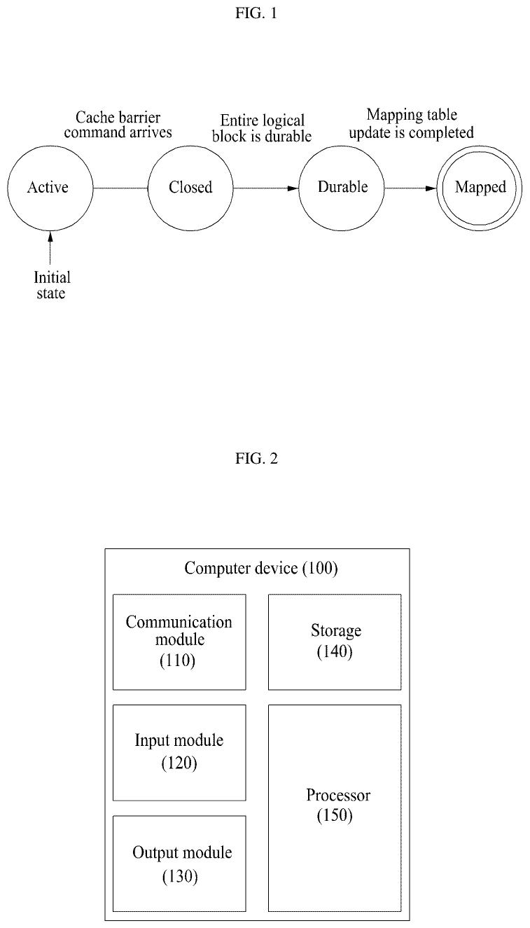

FIG. 1 illustrates a state of an epoch defined in the present disclosure.

Referring to FIG. 1, the present disclosure defines the state of the epoch. The epoch may be in a total of four states, active, closed, durable, and mapped. An initial state of the epoch is an active state and a final state of the epoch is a mapped state. If an epoch data structure is generated, the state of the epoch is the active state. If a cache barrier command of the epoch arrives, the epoch is in the closed state. After write buffer flush is completed, an FTL verifies whether the total number of logical blocks belonging to the epoch is the same as the number of logical blocks recorded in a flash chip. In this process, the entire logical block counter and durable block counter are used. If both values are equal, the FTL changes the state of the epoch from the closed state to the durable state. When mapping information of all logical blocks belonging to the epoch is updated to a mapping table, the FTL changes the state of the epoch from the durable state to the mapped state. To this end, whether a value of the entire logical block counter and a value of the mapped block counter are equal. The FTL determines that the epoch in the mapped state is permanently stored in a storage.

### <Mappable Flag>

In the present disclosure, a write buffer (writeback cache) of the storage stores a mappable flag for each logical block. The mappable flag indicates whether mapping in information of a logical block may be updated when the corresponding logical block is recorded in the storage due to a write buffer flush. The FTL stores two pairs of mappable flags for each logical block of the write buffer. When a write request belongs to all of two streams, two mappable flags are all used. Here, each mappable flag indicates whether mapping information of a logical block may be updated to the table in each stream. The FTL stores two pairs of stream and epoch IDs, [first stream ID, first epoch ID] and [second stream ID, second epoch ID], in the write buffer together with the mappable flags.

### <Settings of Mappable Flag>

A storage controller sets a mappable flag of a logical block when transmitting the logical block to the write buffer. When decoding a write command, the controller determines whether a type of the command is irrelevant to order based on a stream ID value. When the type of the write command is write without order constraints, irrelevant to the write order (unordered write), the controller sets the mappable flag to TRUE. When a first stream ID value is not 0, the controller verifies a state of a previous epoch (epoch ID is 1 less than first epoch ID) and sets a mappable value to TRUE only in the case of the mapped state. When the previous epoch is not in the mapped state, the controller sets the mappable flag to FALSE. When the write command simultaneously belongs to two streams, the controller sets a mappable flag corresponding to each stream, <first mappable flag, second mappable flag>. Only when the state of the previous epoch is the mapped state in each stream, the controller sets the mappable flag to TRUE.

### <Order Guarantee of Write Request>

When the storage controller performs the write buffer flush, the FTL proposed herein reflects page mapping information (LPN, PPN) of a corresponding logical block to the mapping table only when a mappable flag value stored for each logical block of the write buffer is TRUE. If the mappable flag of the logical block is FALSE, the FTL does not record page mapping information (LPN, PPN) of the logical block in the mapping table and adds the same to a delayed mapping information set of a stream to which the logical block belongs. The stream to which the logical block belongs is identified with ID of epoch and stream stored in the write buffer. When the logical block simultaneously belongs to two streams, the controller records mapping information in the mapping table when all of two flag values are TRUE by referring to all of the first mappable flag and the second mappable flag. Every time the mapping table is updated, the FTL verifies whether mapping of all logical blocks in the corresponding epoch is completed. To this end, the FTL verifies whether the entire block counter value and the mapped block counter value are equal. If mapping information of all logical blocks belonging to the epoch is updated, the state of the epoch changes to the mapped state.

### <Sibling-Aware Delayed Mapped>

Entries of a delayed mapping information set of an epoch include a sibling field with LPN and PPN. When even one of mappable flag values of a logical block simultaneously belonging to two streams is FALSE, the FTL adds mapping information (LPN, PPN) of the logical block to delayed mapping information sets of two streams. The FTL stores mutual entry addresses in sibling fields of two entries such that two delayed mapping information entries may refer to each other. The FTL periodically iterates over delayed mapping information sets of all streams and verifies whether a state of a previous epoch is the mapped state. If the state of the previous epoch is the mapped state, the FTL inspects a sibling pointer value. If the value is a null state (NULL), the FTL updates delayed mapping information (LPN, PPN) to the mapping table and removes a corresponding entry from a delayed mapping set. If not NULL, the FTL accesses a sibling delayed mapping entry indicated by the sibling field without updating mapping information and initializes the sibling field to NULL and then removes a current entry form the delayed mapping set.

Hereinafter, various example embodiments of the present disclosure are described with reference to the accompanying drawings.

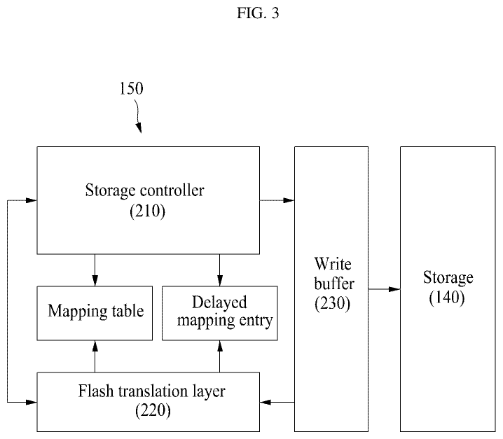

FIG. 2 is a diagram illustrating a schematic configuration of a computer device 100 for updating a dual-order-guaranteed mapping table according to various example embodiments. FIG. 3 is a diagram illustrating a detailed configuration of a processor 150 of FIG. 2.

Referring to FIG. 2, the computer device 100 relates to a double write based on write-ahead, and may include at least one of a communication module 110, an input module 120, an output module 130, a storage 140, and a processor 150. In some example embodiments, at least one (e.g., input module 120, output module 130) of the components of the computer device 100 may be omitted and at least one another component may be added. In some example embodiments, at least two of the components of the computer device 100 may be implemented as a single integrated circuit.

The communication module 110 may perform communication with an external device in the computer device 100. The communication module 110 may establish a communication channel between the computer device 100 and an external device, and may perform communication with the external device. Here, the external device may include at least one of another computer device, a base station, and a server. The communication module 110 may include at least one of a wired communication module and a wireless communication module. The wired communication module may be connected to the external device in a wired manner and may perform communication in a wired manner. The wireless communication module may include at least one of a near-field communication module and a far-field communication module. The near-field communication module may perform communication with the external device using a near-field communication method. For example, the near-field communication method may include at least one of Bluetooth, wireless fidelity (WiFi) direct, and IrDA; infrared data association (IrDA). The far-field communication module may communicate with the external device using a far-field communication method. Here, the far-field communication module may communicate with the external device over a network. For example, the network may include at least one of a cellular network, the Internet, and a computer network such as a local area network (LAN) and a wide area network (WAN).

The input module 120 may input a signal to be used to at least one component of the computer device 100. The input module 120 may be configured to generate a signal by detecting a signal directly input from a user or by detecting a change in surroundings. For example, the input module 120 may include at least one of a mouse, a keypad, a microphone, and a sensing module having at least one sensor. In some example embodiments, the input module 120 may include at least one of a touch circuitry configured to detect a touch and a sensor circuitry configured to measure strength of force generated by the touch.

The output module 130 may output information to the outside of the computer device 100. The output module 130 may include at least one of a display module configured to visually output information and an audio output module configured to output information as an audio signal. For example, the audio output module may include at least one of a speaker and a receiver.

The storage 140 may store a variety of data. For example, the storage 140 may include at least one of a volatile memory and a nonvolatile memory. Data may include at least one program and input data or output data related thereto. The program may be stored in the storage 140 as a software that includes at least one command, and may include at least one of an operating system (OS), middleware, and an application.

The processor 150 may control at least one component of the computer device 100 by executing the program of the storage 140. Through this, the processor 150 may perform data processing or operation. Here, the processor 150 may execute the command stored in the storage 140. In detail, as shown in FIG. 3, the processor 150 may include a storage controller 210, a flash translation layer 220, and a write buffer 230. Here, the write buffer 230 is illustrated to be included in the processor 150, but is not limited thereto. That is, the write buffer 230 may be present within the storage 140.

The storage controller 210 may detect a write command indicating order constraints of write requests for two streams. The streams may be classified into a leader stream and a follower stream according to the order constraints. Here, the order constraints have two constraint conditions. The first constraint condition relates to the leader stream and the second constraint condition relates to between the leader stream and the follower stream. The leader stream may include a leader epoch and a follower epoch after the leader epoch, and the follower stream may include a follower epoch after the same leader epoch. In this case, the write command may be set with a leader ID pair of a leader stream and a leader epoch within the leader stream ([first stream ID, first epoch ID]), and a follower ID pair of a follower stream and the same leader epoch within the follower stream ([second stream ID, second epoch ID]).

The storage controller 210 may generate a mapping table for epochs of streams based on the write command. Here, the mapping table may include fields for storing mapping information of epochs within a corresponding stream in the order of epoch ID for each stream, and the mapping information may include an epoch ID, a logical page address, and a physical page address. Also, the storage controller 210 may generate delayed mapping entries for follower epochs corresponding to each of the streams. Here, each of the delayed mapping entries may include fields for entering an epoch ID, a logical page address, and a physical page address of a corresponding follower epoch, and the delayed mapping entries may further include sibling fields which mutual addresses are entered, respectively.

Also, the storage controller 210 may record, in the storage 140, epochs that are serviced in arbitrary order using the mapping table, according to the constraint order. In detail, the storage controller 210 may transmit the epochs to the write buffer 230 in order in which they are serviced, to be transmitted from the write buffer 230 to the storage 140 according to order constraints. Here, the storage controller 210 may set a mappable flag in a logical block of a corresponding epoch, while transmitting each epoch to the write buffer 230. The mappable flag may be set to TRUE for a leader epoch, may be set to TRUE for a follower epoch after the leader epoch is transmitted, and may be set to FALSE for the follower epoch before the leader epoch is transmitted.

The flash translation layer 220 may update the mapping table with mapping information of each epoch. The flash translation layer 220 may verify the mappable flag of the logical block of the epoch transmitted from the storage controller 210 to the write buffer 230, and may identify the leader epoch and the follower epoch. If the mappable flag is set to TRUE, the flash translation layer 220 may update the mapping table with mapping information that is detected from the corresponding logical block. If the mappable flag is set to FALSE, the flash translation layer 220 may detect mapping information that is detected from the corresponding logical block and may add the same to a delayed mapping entry of the corresponding epoch.

In detail, if the leader epoch is transmitted, the flash translation layer 220 may update the mapping table with mapping information of the leader epoch. Meanwhile, if the follower epoch is transmitted, the flash translation layer 220 may add mapping information of the follower epoch to a delayed mapping entry of the follower epoch. The follower epoch may be transmitted after the leader epoch is transmitted and may also be transmitted before the leader epoch is transmitted. When the follower epoch is transmitted after the leader epoch is transmitted, the flash translation layer 220 may detect mapping information from the delayed mapping entry of the follower epoch, may update the mapping table, and may remove the delayed mapping entry of the follower epoch. Meanwhile, when the leader epoch is transmitted after the follower epoch is transmitted, the flash translation layer 220 may update the mapping table with mapping information of the leader epoch and mapping information of the follower epoch. Here, the flash translation layer 220 may detect mapping information from the delayed mapping entry of the follower epoch, may update the mapping table, and may remove the delayed mapping entry of the follower epoch.

In addition, before removing the delayed mapping entry of the follower epoch, the flash translation layer 220 may verify a sibling field of the delayed mapping entry for the follower epoch. Here, if the mapping table is updated with mapping information of a corresponding epoch, each epoch may change from an initial state to a mapped state (see FIG. 1). Therefore, if the leader epoch changes to the mapped state, the flash translation layer 220 may verify the sibling field of the delayed mapping entry for the follower epoch. If an address is present in the sibling field, the flash translation layer 220 may initialize a sibling field of a delayed mapping entry corresponding to the address to a null state. The flash translation layer 220 may detect mapping information from the delayed mapping entry of the follower epoch, may update the mapping table, and may remove the delayed mapping entry of the follower epoch. Meanwhile, if the sibling field is in the null state, the flash translation layer 220 may detect mapping information from the delayed mapping entry of the follower epoch, may update the mapping table, and may remove the delayed mapping entry of the follower epoch.

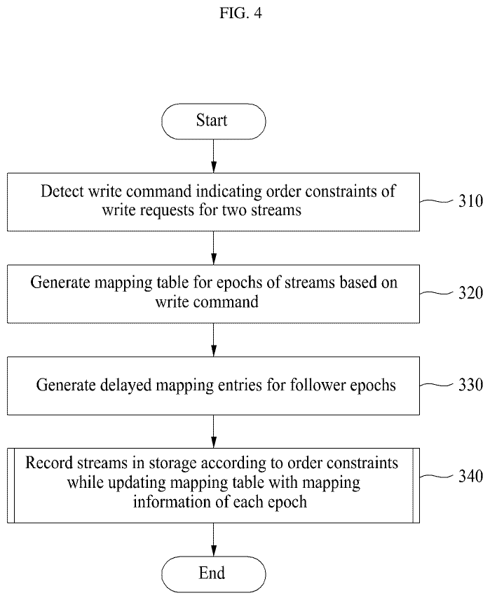

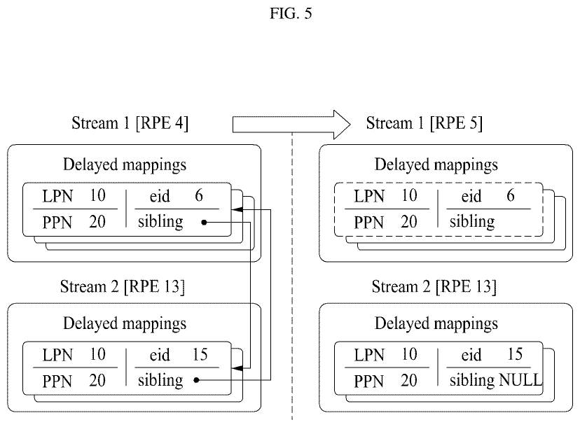

FIG. 4 is a flowchart illustrating a method for updating a dual-order-guaranteed mapping table of the computer device 100 according to various example embodiments. FIG. 5 is a diagram for exemplarily describing operation 330 of generating delayed mapping entries of FIG. 4.

Referring to FIG. 4, in operation 310, the processor 150 may detect a write command indicating order constraints of write requests for two streams. The streams may be classified into a leader stream and a follower stream according to the order constraints. Here, the order constraints have two constraint conditions. The first constraint condition relates to the leader stream and the second constraint condition relates to between the leader stream and the follower stream. The leader stream may include a leader epoch and a follower epoch after the leader epoch, and the follower stream may include a follower epoch after the same leader epoch. In this case, the write command may be set with a leader ID pair of a leader stream and a leader epoch within the leader stream ([first stream ID, first epoch ID]), and a follower ID pair of a follower stream and the same leader epoch within the follower stream ([second stream ID, second epoch ID]).

Then, in operation 320, the processor 150 may generate a mapping table for epochs of streams based on the write command. Here, the mapping table may include fields for storing mapping information of epochs within a corresponding stream in the order of epoch ID for each stream, and the mapping information may include an epoch ID, a logical page address, and a physical page address. Also, in operation 330, the processor 150 may generate delayed mapping entries for follower epochs, as shown in FIG. 5, corresponding to each of the streams. Here, each of the delayed mapping entries may include fields for entering an epoch ID, a logical page address, and a physical page address of a corresponding follower epoch, and, as shown in FIG. 5, the delayed mapping entries may further include sibling fields which mutual addresses are entered, respectively.

Then, in operation 340, the processor 150 may store streams in the storage 140 according to order constraints using the mapping table, while updating the mapping table with mapping information of each epoch. In detail, the storage controller 210 may transmit epochs to the write buffer 230 in order in which they are serviced, to be transmitted from the write buffer 230 to the storage 140 according to order constraints. Here, the storage controller 210 may set a mappable flag in a logical block of a corresponding epoch, while transmitting each epoch to the write buffer 230. The mappable flag may be set to TRUE for a leader epoch, may be set to TRUE for a follower epoch after the leader epoch is transmitted, and may be set to FALSE for the follower epoch before the leader epoch is transmitted. The flash translation layer 220 may verify the mappable flag of the logical block of the epoch transmitted from the storage controller 210 to the write buffer 230 and may identify the leader epoch and the follower epoch. If the mappable flag is set to TRUE, the flash translation layer 220 may update the mapping table with mapping information that is detected from the corresponding logical block. If the mappable flag is set to FALSE, the flash translation layer 220 may detect mapping information that is detected from the corresponding logical block and may add the same to a delayed mapping entry of the corresponding epoch.

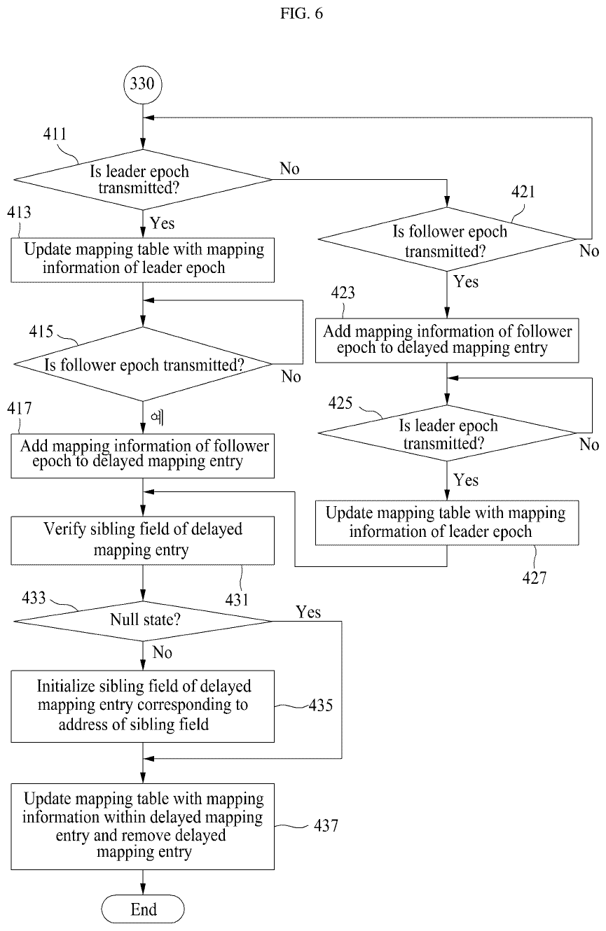

FIG. 6 is a flowchart illustrating operation 340 of recording streams while updating the mapping table of FIG. 4 in more detail.

Referring to FIG. 6, when the leader epoch is first transmitted, the processor 150 may verify this in operation 411 and may update the mapping table with mapping information of the leader epoch in operation 413. Then, when the follower epoch is transmitted, the processor 150 may verify this in operation 415, and may add mapping information of the follower epoch to the delayed mapping entry for the follower epoch in operation 417.

Meanwhile, when the follower epoch is first transmitted, the processor 150 may verify this in operation 421 and may add mapping information of the follower epoch to the delayed mapping entry for the follower epoch in operation 423. Then, when the leader epoch is transmitted in operation 425, the processor 150 may update the mapping table with mapping information of the leader epoch in operation 427.

After operation 417 or 427, the processor 150 may verify a sibling field of the delayed mapping entry for the follower epoch in operation 431. In operation 433, the processor 150 may verify whether the sibling field is in a null state or whether an address is in the sibling field. If the sibling field is in the null state in operation 433, the processor 150 may update the mapping table with mapping information within the delayed mapping entry of the follower epoch and may remove the delayed mapping entry of the follower epoch as shown in an upper portion of FIG. 5, in operation 437. Meanwhile, if the address is present in the sibling field in operation 433, the processor 150 may initialize the sibling field of the delayed mapping entry corresponding to the address to the null state as shown in a lower portion of FIG. 5, in operation 435. Then, in operation 437, the processor 150 may update the mapping table with mapping information within the delayed mapping entry of the follower epoch and may remove the delayed mapping entry of the follower epoch as shown in the upper portion of FIG. 5.

According to the present disclosure, it is possible to guarantee the order in which a write command simultaneously belonging to two streams is permanently recorded. By delaying mapping information update of a write command that violates the order and by performing data recording on a flash chip regardless of the order, it is possible to guarantee the write order while minimizing overhead required for guaranteeing the order.

The apparatuses described herein may be implemented using hardware components, software components, and/or a combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, or a computer storage medium or device to be interpreted by the processing device or to provide an instruction or data to the processing device. The software also may be distributed over network coupled computer systems so that the software is stored and executed in a distributed fashion. The software and data may be stored by one or more computer readable storage media.

The methods according to various example embodiments may be configured in a form of program instructions that may be performed through various computer methods and recorded in computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

According to various example embodiments, each of the aforementioned components (e.g., module or program) may include a singular object or a plurality of objects. According to various example embodiments, among the aforementioned components, one or more components or operations may be omitted or one or more other components or operations may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by modules, programs, or other components may be executed sequentially, in parallel, iteratively, or heuristically, or one or more of the operations may be executed in different order or omitted, or one or more other operations may be added.

What is claimed is:

1. A computer device for updating a dual-order-guaranteed mapping table, the computer device comprising:
a storage; and
a processor configured to connect to the storage, and to execute at least one instruction stored in the storage,
wherein the processor comprises:
a storage controller configured to detect a write command indicating order constraints of write requests for two streams, to generate a mapping table for epochs of the streams based on the write command, and to record the streams in the storage according to the order constraints using the mapping table; and
a flash translation layer configured to update the mapping table with mapping information of each epoch.

2. The computer device of claim 1, wherein the storage controller is configured to generate delayed mapping entries for the respective follower epochs after the same leader epoch corresponding to each of the streams, and
the delayed mapping entries have sibling fields into which mutual addresses are entered, respectively.

3. The computer device of claim 2, wherein the storage controller is configured to transmit the epochs to a write buffer in order in which the epochs are serviced, to be transmitted from the write buffer to the storage according to the order constraints, and
the flash translation layer is configured to,
when the follower epoch is transmitted for each stream, add mapping information of the follower epoch to a delayed mapping entry for the follower epoch, and
when the leader epoch is transmitted after the follower epoch is transmitted, update the mapping table with mapping information of the leader epoch and the mapping information of the follower epoch.

4. The computer device of claim 3, wherein the flash translation layer is configured to,
when the leader epoch is transmitted after the follower epoch is transmitted, update the mapping table with the mapping information of the leader epoch,
identify a sibling field of the delayed mapping entry for the follower epoch,
when an address is present in the sibling field, initialize a sibling field of a delayed mapping entry corresponding to the address to a null state, update the mapping table with the mapping information of the follower epoch, and remove the delayed mapping entry of the follower epoch, and
when the sibling field is in the null state, update the mapping table with the mapping information of the follower epoch, and remove the delayed mapping entry of the follower epoch.

5. The computer device of claim 3, wherein
the storage controller is configured to set a mappable flag in a logical block of each epoch,
the mappable flag is set to TRUE for the leader epoch, set to TRUE for the follower epoch after the leader epoch is transmitted, and set to FALSE for the follower epoch before the leader epoch is transmitted, and
the flash translation layer is configured to, when the mappable flag is set to FALSE in a logical block of an epoch transmitted from the storage controller to the write buffer, detect mapping information of the epoch in the logical block of the epoch and add the same to a delayed mapping entry of the epoch.

6. The computer device of claim 4, wherein each epoch changes from an initial state to a mapped state in response to the mapping table being updated with the mapping information of the epoch, and
the flash translation layer is configured to, when the leader epoch changes to the mapped state, identify the sibling field of the delayed mapping entry for the follower epoch.

7. A method for updating a dual-order-guaranteed mapping table of a computer device, the method comprising:
detecting a write command indicating order constraints of write requests for two streams;
generating a mapping table for epochs of the streams based on the write command; and
recording the streams in the storage according to the order constraints using the mapping table while updating the mapping table with mapping information of each epoch.

8. The method of claim 7, further comprising:
generating delayed mapping entries for the respective follower epochs after the same leader epoch corresponding to each of the streams,
wherein the delayed mapping entries have sibling fields into which mutual addresses are entered, respectively.

9. The method of claim 8, wherein the storing in the storage comprises:
transmitting the epochs to a write buffer in order in which the epochs are serviced, to be transmitted from the write buffer to the storage according to the order constraints;
when the follower epoch is transmitted for each stream, adding mapping information of the follower epoch to a delayed mapping entry for the follower epoch; and
when the leader epoch is transmitted after the follower epoch is transmitted, updating the mapping table with mapping information of the leader epoch and the mapping information of the follower epoch.

10. A non-transitory computer-readable recording medium in which a computer program for executeing a method for updating a dual-order-guaranteed mapping table on a computer device is recorded, wherein the method comprises:
detecting a write command indicating order constraints of write requests for two streams;
generating a mapping table for epochs of the streams based on the write command; and
recording the streams in the storage according to the order constraints using the mapping table while updating the mapping table with mapping information of each epoch.
